(19) United States
(12) Patent Application Publication
(10) Pub. No.: US 2006/0151223 A1
(43) Pub. Date: Jul. 13, 2006

(54) Device and method for improving visibility in a motor vehicle

(76) Inventor: Peter Knoll, Ettlingen (DE)

Correspondence Address: KENYON & KENYON LLP, ONE BROADWAY, NEW YORK, NY, 10004, US

(21) Appl. No.: 10/535,131

(22) PCT Filed: Sep. 23, 2003
(86) PCT No.: PCT/DE03/03152

§ 371 Date: Jan. 6, 2006

(30) Foreign Application Priority Data
Nov. 16, 2002 (DE) 102 53 510.8

(51) Int. Cl. B60T 7/16

(52) U.S. Cl. 180/169

(57) ABSTRACT

An apparatus and a method are proposed for improving the visibility in a motor vehicle having an infrared-sensitive image sensor system. Via a signaling arrangement, for example, a monitor or a head-up display, items of driver information concerning the course of the roadway and/or objects in the surrounding area of the motor vehicle are displayed to the driver of the motor vehicle. The displaying of the items of driver information takes place as a function of the course of the roadway.

### FIELD OF THE INVENTION

The invention relates to an apparatus and a method for improving visibility in a motor vehicle having at least one infrared-sensitive image sensor system.

### BACKGROUND INFORMATION

The visibility conditions experienced by the driver of a motor vehicle influence the frequency of accidents in street traffic, and thus influence traffic safety. In addition to lighting conditions, weather conditions determine the driver's ability to see. For example, it is known that a higher percentage of fatal traffic accidents happen at night. Fog, rain, and snow also make visibility conditions worse. Especially poor conditions are present when the lighting conditions and the weather conditions are both poor, e.g. when rain reduces visibility at night.

From German Patent No. 40 32 927, an apparatus is known for improving visibility conditions in a motor vehicle having an infrared-sensitive camera and a display device formed as a head-up display. It is proposed that, as information for the driver, the camera image be superposed as a virtual image of the outer landscape. In order to illuminate the field of view acquired by the infrared-sensitive camera, a radiation source having an infrared radiation portion is used. The evaluation of the display is left to the driver.

### SUMMARY OF THE INVENTION

The apparatus and the method of the present invention result in an improvement of the visibility in a motor vehicle while at the same time reducing stress on the driver. This advantage is achieved by controlling the at least one signaling means for producing the driver information, as a function of the course of the roadway. Drivers of today's modern motor vehicles have to process a large amount of information from street traffic and from the motor vehicle itself. The apparatus described below and the method enable an advantageous reduction in the amount of information that has to be processed by the driver. This results, particularly advantageously, in a high degree of acceptance by the driver. In addition, the apparatus and the method for reducing the number of accidents in street traffic in poor lighting and/or weather conditions can contribute in particular to a reduction in the number of accidents that take place at night.

Due to the use of spatially high-resolution image sensor systems, for example having a resolution of 1280×1024 pixels, the number of objects that can be acquired in the surrounding environment of the motor vehicle is high. The allocation of the acquired objects in the field of detection of the image sensor system to the course of the roadway provides a simple decision criterion for reducing the number of objects to be represented. By controlling the at least one signaling means for producing the driver information as a function of the position of at least one object in relation to the course of the roadway, a stimulus overload of the driver is advantageously prevented. It is especially advantageous that the apparatus and the method described below reduce the distraction of the driver to a minimum. This advantageously increases overall traffic safety. In addition, the allocation of the acquired objects to the course of the roadway as a decision criterion enables the use of simple, economical processing units.

The controlling of the signaling means for producing the driver information as a function of the driving situation and/or the visibility conditions results in additional advantages of the apparatus described below and of the method. In this way, a further reduction of the quantity of information that a driver of a motor vehicle must process is advantageously achieved by displaying only information that is important for the driver. For example, the apparatus described below and the method enable a situation-specific warning of the driver concerning obstacles in the course of the roadway, i.e., in the driver's own lane and in adjacent areas, that the driver does not see when traveling at night with low beams. The controlling of the signaling means for producing the driver information as a function of the visibility conditions makes it possible to warn the driver so that he can react in timely fashion to an obstacle. In this way, accidents are advantageously prevented. However, at the same time it is possible to omit a warning of an obstacle if the obstacle, not visible to the driver, does not present a danger.

Items of driver information, suitable for the representation of at least one object and/or of the course of the roadway, make it possible for the driver advantageously to register the course of the roadway and to rapidly and reliably himself recognize dangers presented by objects. For example, at night it is often difficult for the driver to see the course of the roadway itself. Through the simultaneous representation of the course of the roadway and of objects, a driver can judge whether objects represent a danger.

Through the use of at least one light pulse in the field of view of the driver in order to warn him, and/or at least one warning symbol, and/or at least one image marking, and/or at least one segment of an image, and/or at least one acoustic signal, and/or at least one optical signal as items of driver information, the quantity of information affecting the driver is reduced. Through this well-directed warning of the driver via one or more possible information paths, the danger of distracting the driver is advantageously reduced.

By using at least one source of infrared radiation to illuminate at least a part of the surrounding environment of the motor vehicle, acquired by the infrared-sensitive image sensor system, the sensitivity and the spatial area of acquisition of the image sensor system are advantageously increased. The infrared radiation source makes it possible for the at least one image sensor system to acquire objects that do not give off infrared radiation.

A computer program having program code means is especially advantageous for the execution of all steps of the method described below, if the program is executed on a computer. The use of a computer program enables the rapid and economical adaptation of the method to different image sensor systems and/or signaling means.

### BRIEF DESCRIPTION OF THE DRAWINGS

FIG. 1 shows an overview drawing of a first exemplary embodiment for improving the visibility in a motor vehicle.

FIG. 2 shows an overview drawing of a second exemplary embodiment for improving the visibility in a motor vehicle.

FIG. 3 shows a block diagram of the apparatus for improving the visibility in a motor vehicle.

FIG. 4 shows a flow diagram.

### DETAILED DESCRIPTION

In the following, an apparatus and a method for improving the visibility in a motor vehicle having an infrared-sensitive image sensor system are described. Via a signaling means, for example a monitor or a head-up display, the driver of the motor vehicle is given driver information concerning the course of the roadway and/or objects in the surrounding environment of the motor vehicle. The displaying of the driver information here takes place as a function of the course of the roadway.

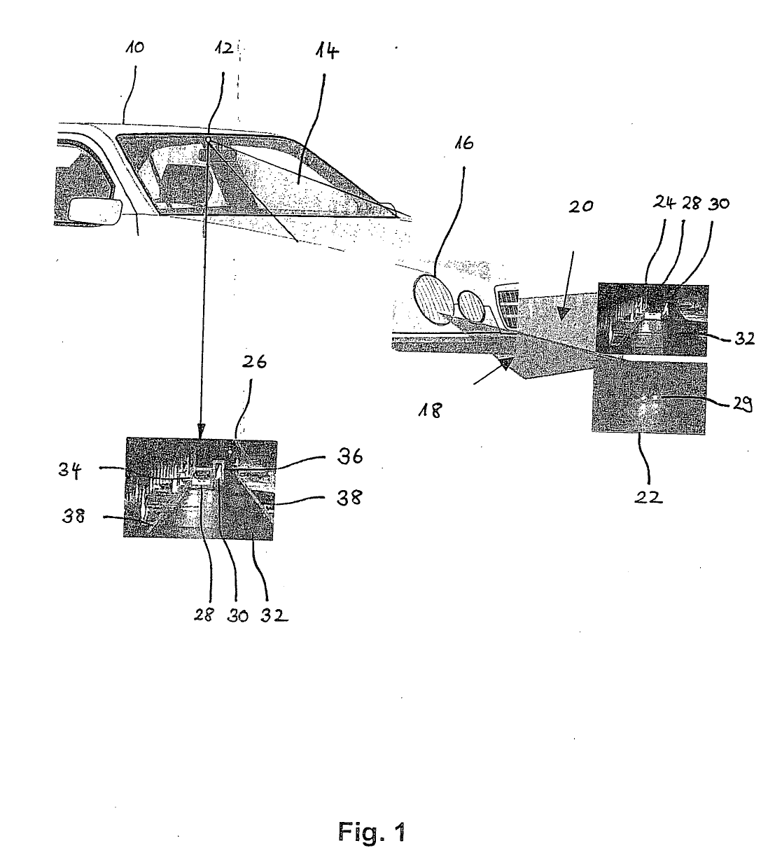

FIG. 1 shows an overview drawing of a first exemplary embodiment for improving the visibility in a motor vehicle 10, made up of an infrared-sensitive image sensor system 12, a headlight 16, and an image on a display screen 26. Image sensor system 12 is situated in the interior of motor vehicle 10, behind the windshield, in the area of the interior rearview mirror. Image sensor system 12 is oriented in such a way that area of acquisition 14 of image sensor system 12 extends to the surrounding environment of motor vehicle 10 in the direction of travel. Image sensor system 12 includes an infrared-sensitive video camera having a CMOS image sensor and/or a CCD image sensor. The image sensor of image sensor system 12 acquires at least near infrared radiation in the wavelength range between 780 nm and 1000 nm. Motor vehicle 10 is driven by a driver, motor vehicle 10 being situated on a street and traveling in the direction of travel. In the situation shown in FIG. 1, the weather conditions and the lighting conditions are poor, because darkness is adversely affecting the driver's view. Two headlights 16, situated at the right and at the left in the front area of motor vehicle 10, in the vicinity of the bumper, illuminate the surrounding environment of motor vehicle 10 in the direction of travel. In FIG. 1, in a simplified representation only one headlight 16 is shown. In addition to the low-beam light 18 in the visible light spectral range, headlights 16 also produce radiation having a high-beam characteristic 20 in the infrared spectral range. The range of low-beam 18 is approximately 40 meters. Headlights 16 have a high-beam function in the visible spectral range, with which the driver can see up to 200 meters, depending on weather conditions. In this exemplary embodiment, the high-beam function in the visible spectral range is not activated. The radiated spectrum of the halogen lamps of headlights 16 contain a large infrared portion that is radiated by these modified headlights 16 with a high-beam characteristic, in a manner invisible to human beings. The driver's perception 22 is strongly limited by the darkness. In contrast, infrared-sensitive image sensor system 12 achieves a better perception 24 through the modification of front headlights 16, having radiation at least of near infrared radiation with wavelengths between 780 and 1000 nm with high-beam characteristic 20. In the perception 24 of infrared-sensitive image sensor system 12, an oncoming motor vehicle 28, a pedestrian 30, and roadway 32 can be seen, while in driver's perception 22 only headlights 29 of oncoming motor vehicle 28 can be recognized. In perception 24 of image sensor system 12, pedestrian 30, crossing behind oncoming motor vehicle 28, can be recognized clearly, while in the driver's perception 22 he is not visible. Perception 24 of infrared-sensitive image sensor system 12 is processed and is displayed, as an image on a display screen 26, to the driver of motor vehicle 10. As a display screen, a monitor is used that is situated in the dashboard of motor vehicle 10. This display screen can be situated in the area of the center console and/or in the multi-instrument panel of motor vehicle 10, immediately behind the steering wheel. Besides the displaying of the speed and/or RPM by the multi-instrument panel, it is also possible for the driver to see the image of the surrounding environment of motor vehicle 10 without changing the direction of his gaze. With the aid of suitable image processing algorithms, objects 28, 30 in the field of detection, i.e. in the area of the course of the roadway, are recognized, and objects 28, 30 are allocated to the course of the roadway. Roadway 32 here fundamentally includes the driver's lane and the lane of the oncoming traffic. On highways, roadway 32 is formed by at least the driver's lanes. Roadway 32 is defined by roadway markings such as guideposts and/or lane marking lines. The course of the roadway here includes roadway 32 itself and areas adjacent to roadway 32, such as for example edge strips and/or footpaths and/or bicycle paths and/or entrances of streets. In this exemplary embodiment, an oncoming motor vehicle 28 and a pedestrian 30 are recognized as objects 28, 30. In the image on display screen 26, the image recorded by infrared-sensitive image sensor system 12 of the surrounding environment of motor vehicle 10 is displayed with a marking 34 of oncoming motor vehicle 28, a marking 36 of pedestrian 30, and a marking of the course 38 of roadway 32. This image on display screen 26, with inserted markings 34, 36, 38, is shown to the driver of motor vehicle 10. Through markings 34, 36, 38, the driver recognizes objects 28, 30 significantly faster than would be the case if only the unprocessed image information of infrared-sensitive image sensor system 12 were displayed, and can easily allocate them to his driving lane. In this exemplary embodiment, the image processing algorithms are designed so that the course of the roadway 38 is always marked, while markings 34, 36 of objects 28, 30 are executed only if objects 28, 30 are situated in the area of the course of the roadway of motor vehicle 10. In an embodiment, the optical warning via markings 34, 36, 38 is additionally supported by an acoustic warning if a dangerous situation is recognized. Via a loudspeaker, the driver of motor vehicle 10 can be additionally warned acoustically. In this exemplary embodiment, a dangerous situation is recognized because pedestrian 30 is crossing roadway 32 behind oncoming motor vehicle 28, and there is the danger of a collision of the driver's vehicle 10 with pedestrian 30.

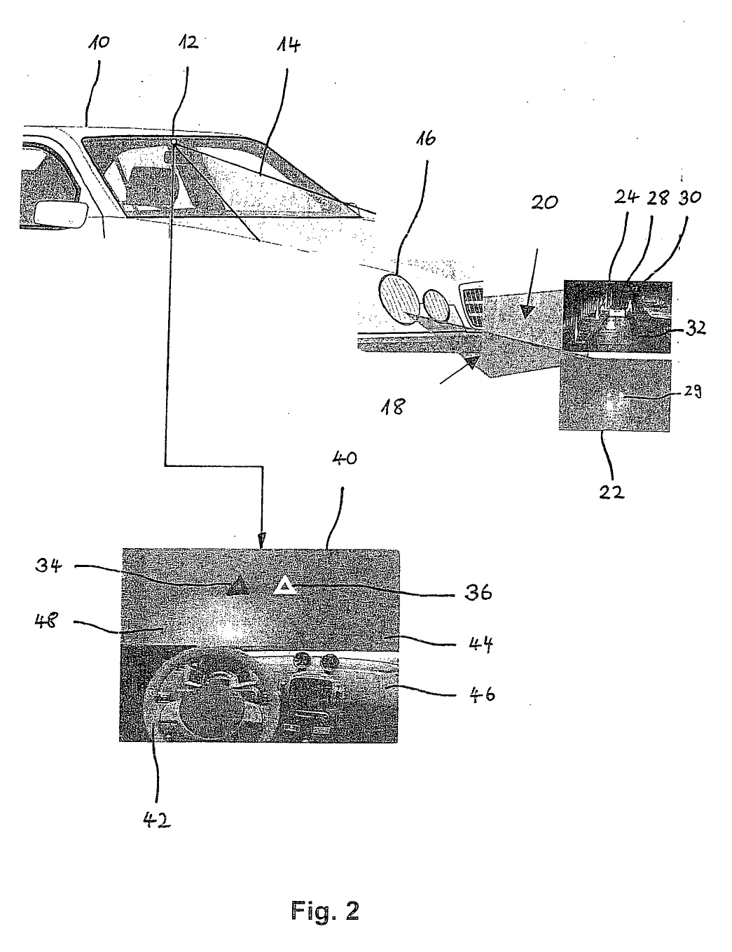

FIG. 2 shows an overview drawing of a second exemplary embodiment for improving visibility in a motor vehicle 10, made up of an infrared-sensitive image sensor system 12, a headlight 16, and the actual view of driver 40 of motor vehicle 10. As in the first exemplary embodiment according to FIG. 1, image sensor system 12 is situated in the interior of motor vehicle 10, behind the windshield, in the area of the interior rearview mirror. Image sensor system 12 is oriented in such a way that area of acquisition 14 of image sensor system 12 extends to the surrounding environment of motor vehicle 10 in the direction of travel. Image sensor system 12 includes an infrared-sensitive video camera having a CMOS image sensor and/or a CCD image sensor. The image sensor of image sensor system 12 acquires at least near infrared radiation in the wavelength range between 780 nm and 1000 nm. Motor vehicle 10 is driven by a driver, motor vehicle 10 being situated on a street and traveling in the direction of travel. The same driving situation is present as in the first exemplary embodiment according to FIG. 1. The weather conditions and the lighting conditions are poor, because darkness is adversely affecting the driver's view. Two headlights 16, situated at the right and at the left in the front area of motor vehicle 10, in the vicinity of the bumper, illuminate the surrounding environment of motor vehicle 10 in the direction of travel. In FIG. 2, in a simplified representation only one headlight 16 is shown. In addition to the low-beam light 18 in the visible spectral range, headlights 16 also produce radiation having a high-beam characteristic 20 in the infrared spectral range. The range of low-beam light 18 is approximately 40 meters. Headlights 16 have a high-beam function in the visible spectral range, with which the driver can see up to 200 meters, depending on weather conditions. In this exemplary embodiment, the high-beam function in the visible spectral range is not activated. The radiated spectrum of the halogen lamps of headlights 16 contain a large infrared portion that is radiated by these modified headlights 16 with a high-beam characteristic, in a manner invisible to human beings. The driver's perception 22 is strongly limited by the darkness. In contrast, infrared-sensitive image sensor system 12 achieves a better perception 24 through the modification of front headlights 16, having radiation at least of near infrared radiation with wavelengths between 780 and 1000 nm with high-beam characteristic 20. In the perception 24 of infrared-sensitive image sensor system 12, an oncoming motor vehicle 28, a pedestrian 30, and roadway 32 can be seen, while in driver's perception 22 only headlights 29 of oncoming motor vehicle 28 can be recognized. In perception 24 of image sensor system 12, pedestrian 30, crossing behind oncoming motor vehicle 28, can be seen clearly, while in driver's perception 22 he is not visible. FIG. 2 additionally shows the actual view of driver 40, including steering wheel 42, windshield 44, and dashboard 46. In this second exemplary embodiment, perception 24 of infrared-sensitive image sensor system 12 is supplied to a processing unit that produces a warning only if a dangerous situation is recognized. With the aid of suitable image processing algorithms, objects 28, 30 in the field of detection, i.e. in the area of the roadway, are recognized, and objects 28, 30 are allocated to the course of the roadway. As in the exemplary embodiment according to FIG. 1, roadway 32 here fundamentally includes the driver's lane and the lane of the oncoming traffic. On highways, roadway 32 is formed by at least the driver's lanes. Roadway 32 is defined by roadway markings such as guideposts and/or lane marking lines. The course of the roadway here includes roadway 32 itself and areas adjacent to roadway 32, such as for example edge strips and/or footpaths and/or bicycle paths and/or entrances of streets. In this exemplary embodiment, an oncoming motor vehicle 28 and a pedestrian 30 are recognized as objects 28, 30. The processing unit recognizes the dangerousness of the situation. Via a simple projection device, in this exemplary embodiment a simple head-up display, on windshield 44 a small warning symbol 34, 36 is produced as marking 34 of oncoming motor vehicle 28 and as marking 36 of pedestrian 30 in the direction of view of the driver, at the position, thus determined, of oncoming motor vehicle 28 and of pedestrian 30. In this way, the driver is made to direct his gaze in the direction in which objects 28, 30 will later actually appear to the driver as obstacles in his field of view. In this exemplary embodiment, a colored marking in the form of a red and/or yellow triangle is used as warning symbol 34, 36. Alternatively, it is possible, using a short light impulse, to cause the driver to direct his gaze in the direction of the obstacle, using a projection device. The view of driver 40 of the surrounding environment of motor vehicle 10 according to FIG. 2 accordingly includes the light 48 from the headlights of oncoming motor vehicle 28, a marking 34 of oncoming motor vehicle 28, and a marking 36 of pedestrian 30. These markings 34, 36 direct the attention of the driver of motor vehicle 10 to these objects 28, 30. The image processing algorithms are designed so that the marking 34, 36 of objects 28, 30 takes place only if objects 28, 30 are situated in the area of the course of the roadway of motor vehicle 10, and if a dangerous situation is present. In this exemplary embodiment, a dangerous situation is recognized because pedestrian 30 is crossing roadway 32 behind oncoming motor vehicle 28, and there is the danger of a collision of the driver's vehicle 10 with pedestrian 30.

In the two exemplary embodiments according to FIGS. 1 and 2, image sensors are used that have a high resolution. Usable semiconductor image recording chips have resolutions that are sufficient for a satisfactory image representation and that enable object recognition at distances up to approximately 70 meters. A recognition of objects located further than 70 meters from the image sensor requires higher-resolution image sensors (imagers) having standard resolutions with 1024×768 pixels or 1280×1024 pixels. With standard resolutions of 1024×768 pixels, an object recognition up to approximately 110 meters is possible, while with a standard resolution of 1280×1024 pixels an object recognition up to approximately 140 meters can be carried out. In the two exemplary embodiments according to FIGS. 1 and 2, the coating of the camera optics is adapted to the spectral range used. The coating is designed so that the optical characteristics in the visible spectral range are not significantly worsened. In this way, is possible also to use the image sensor system for other functions in daylight, i.e., in the visible spectral range. In addition, the aperture of the optics is adapted to the prevailing dark sensitivity.

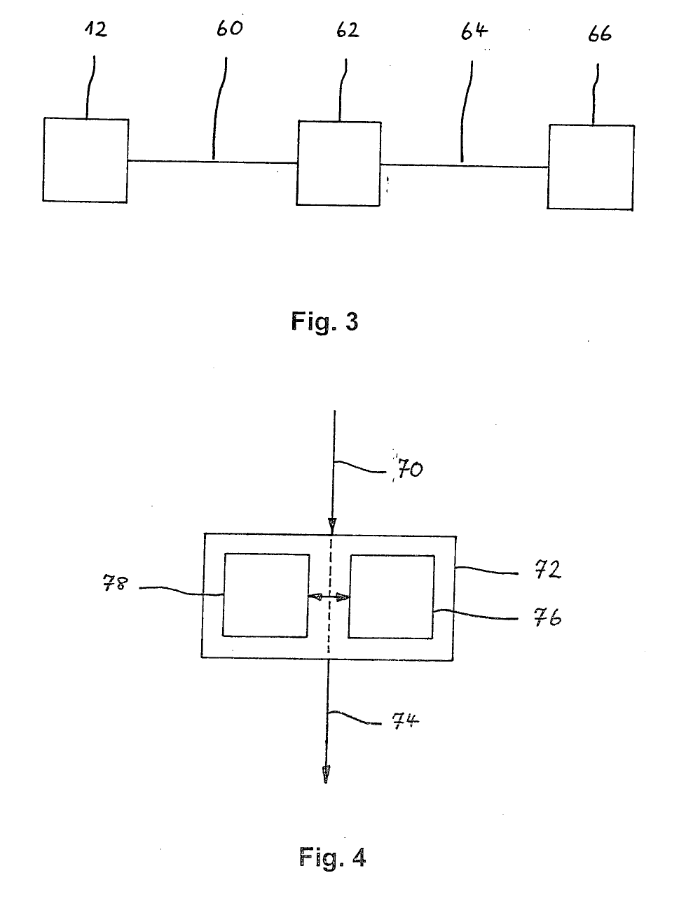

FIG. 3 shows a block diagram of the first and second exemplary embodiments, corresponding to FIGS. 1 and 2, of the apparatus for improving visibility in a motor vehicle, made up of an infrared-sensitive image sensor system 12, a processing unit 62, and at least one signaling means 66. Infrared-sensitive image sensor system 12 acquires optical signals from the surrounding environment of the motor vehicle in the form of image data. Via signal line 60, the optical signals are transmitted electrically and/or optically from infrared-sensitive image sensor system 12 to processing unit 62. Alternatively, or additionally, transmission by radio is possible. Processing unit 62 is made up of module 72, shown in FIG. 4, which in these exemplary embodiments is realized as programs of at least one microprocessor. In this exemplary embodiment, processing unit 62 is physically separated from the other components 12, 66. Alternatively, it is possible for processing unit 62 to form a unit together with image sensor system 12, or for processing unit 62 to be housed in signaling means 66. Processing unit 62 calculates, from the optical signals of infrared-sensitive image sensor system 12, signals for driver information. The calculated signals for driver information are electrically and/or optically transmitted to at least one signaling means 66 via a signal line 64. Alternatively, or additionally, a transmission by radio is possible. From the signals for driver information, signaling means 66 produce the actual driver information, for example in the form of an optical and/or an acoustic warning. As signaling means 66, in the first exemplary embodiment a display in the multi-instrument panel is used as a first signaling means 66, and a loudspeaker is used as a second signaling means 66, while in the second exemplary embodiment a projection device is used.

FIG. 4 shows a flow diagram of the first and second exemplary embodiments, corresponding to FIGS. 1 and 2, of the method for improving visibility in a motor vehicle, and of the apparatus according to FIG. 3, made up of processing module 72. Optical signals 70 are supplied to processing module 72, which calculates, as output signals, the signals for driver information 74. The processing module is made up of two modules that work in parallel; these are the module for roadway course recognition 76 and the module for object recognition 78. The algorithms for lane and/or roadway recognition of the module for roadway course recognition 76 and for object recognition of object recognition module 78 are joined to form an overall algorithm. These two modules 76, 78 exchange information and partial results during the processing. In the module for roadway course recognition 76, from optical signals 70 objects are determined that define the roadway or the lane. These objects are for example guideposts and/or lane marking lines. The course of the roadway is calculated using the knowledge of the position of these objects. The objects for calculating the course of the roadway are determined by evaluating contrasts in the image. For example, in order to determine the lane marking lines, contrasts differences between the lane markings and the roadway surface are evaluated and are traced by the processing unit in the image sequence. Irregularities and/or brief interruptions of the lines are corrected, for example using Kalman filtering algorithms. In the module for object recognition 78, objects are likewise determined from the optical signals. For the object detection, contrast differences between the object and its surroundings are evaluated. In a variant of the described method, a determination of the distance of the detected objects is carried out using a stereo camera. From the size of the outline of the object and its distance, it is possible to determine the size of the object. Objects that are recognized include in particular oncoming motor vehicles and/or pedestrians and/or bicyclists and/or motorcyclists and/or trucks. In a first variant, objects are merely recognized as such, while in a further variant an object classification is carried out. A comparison between a recognized image pattern, for example the shape and/or the size of the object, and an image pattern stored in the processing unit forms the basis for the object classification. Subsequently, a calculation of the three-dimensional position of the recognized objects in relation to the determined course of the roadway is carried out. Using this overall algorithm, it is possible to carry out an allocation of an object to the course of the roadway, in particular to the lane and/or to the roadway.

The described apparatus and the method are not limited to a single image sensor system. Rather, in a variant additional image sensor systems are used whose optical signals are supplied to the at least one processing unit. Here, the image sensor systems are equipped with color image sensors and/or black-and-white image sensors. In an additional variant, at least one image sensor system is used that is made up of at least two image sensors that record essentially the same scene. In another variant, at least one stereo camera is used.

In a further variant of the described apparatus and of the method, besides at least one like pulse and/or at least one warning symbol and/or at least one image marking and/or an acoustic signal, alternatively or additionally at least one segment of an image and/or a haptic signal are produced as driver information. These possibilities are used either individually or in arbitrary combinations.

A further variant of the described apparatus contains, besides the at least one optical signaling means and/or the at least one acoustic signaling means, alternatively or additionally at least one haptic signaling means. These signaling means are used either individually or in arbitrary combinations.

In a further variant of the described apparatus and of the method, the processing unit alternatively or additionally takes into account the visibility conditions. The visibility conditions are defined here by the view of the driver. In this variant, the inclusion of the visibility conditions means that the driver is warned only of objects that he himself cannot see. This results in a reduction of the quantity of information that has to be processed by the driver.

A further variant provides that, instead of the modified headlight with halogen lamp according to one of the preceding exemplary embodiments, an infrared-laser-based headlight is used as a source of infrared radiation.

In a further variant of the described apparatus and of the method, more than one processing unit is used. In this way, a distribution of the algorithms to a plurality of processing units is possible. At the same time, there is a redundancy of the required computing capacity, so that when there is a failure of a processing unit, the apparatus and the method for improving visibility continue to remain capable of functioning, because the remaining processing units compensate for the failure.

In a further variant of the described apparatus and of the method, the use of at least one additional sensor enables an improvement of the visibility in a motor vehicle. Through the use of at least one additional sensor and the fusion of the sensor signals with the produced optical signals, a more reliable recognition of the course of the roadway and/or of the objects is attained. As the at least one additional sensor, at least one radar sensor and/or at least one ultrasonic sensor and/or at least one LIDAR distance sensor are used. The use of at least one additional sensor enables the redundant determination of the position of at least one object and/or of the course of the roadway.

1.-11. (canceled)

12. An apparatus for improving a visibility in a motor vehicle, comprising:
at least one infrared-sensitive image sensor system for acquiring an optical signal from a surrounding environment of the motor vehicle;
at least one signaling arrangement for producing an item of driver information; and
at least one processing unit for controlling the at least one signaling arrangement as a function of the acquired optical signal, wherein:
the at least one processing unit includes an arrangement for recognizing a course of a roadway from at least the optical signal, and for controlling the at least one signaling arrangement for producing the item of driver information as a function of the recognized course of the roadway.

13. The apparatus as recited in claim 12, wherein:
the at least one processing unit includes an arrangement for recognizing at least one object, from at least the optical signal, and for controlling the at least one signaling arrangement as a function of a position of the at least one recognized object in relation to the course of the roadway.

14. The apparatus as recited in claim 13, wherein:
the at least one object includes at least one of at least one other motor vehicle and at least one pedestrian.

15. The apparatus as recited in claim 12, wherein:
the at least one processing unit includes an arrangement for controlling the at least one signaling arrangement as a function of at least one of a dangerousness of a driving situation and of a visibility condition.

16. The apparatus as recited in claim 13, further comprising:
at least one sensor including at least one of at least one radar sensor, at least one ultrasonic sensor, and at least one LIDAR distance sensor, wherein:
the at least one processing unit includes an arrangement for carrying out at least one of the recognition of the course of the roadway and the recognition of the at least one object as a function of a signal of the at least one additional sensor.

17. The apparatus as recited in claim 12, wherein:
the item of driver information represents at least one object including at least one of at least one other motor vehicle, at least one pedestrian, and the course of the roadway.

18. The apparatus as recited in claim 12, wherein:
the item of driver information include at least one of at least one light pulse, at least one warning symbol, at least one image marking, at least one segment of an image, at least one acoustic signal, and at least one haptic signal.

19. The apparatus as recited in claim 12, further comprising:
at least one infrared radiation source for illuminating at least a part of the surrounding environment, acquired by the at least one infrared-sensitive image sensor system, of the motor vehicle.

20. The apparatus as recited in claim 12, wherein:
the at least one signaling arrangement includes one of at least one acoustic signaling arrangement and at least one optical signaling arrangement corresponding to at least one of at least one head-up display, at least one display screen, and at least one haptic signaling arrangement.

21. A method for improving a visibility in a motor vehicle, comprising:
acquiring, by at least one infrared-sensitive image sensor system, an optical signal from a surrounding environment of the motor vehicle;
controlling, by at least one processing unit, at least one signaling arrangement in order to produce an item of driver information as a function of the acquired optical signal; and
recognizing, by the at least one processing unit, a course of a roadway from at least the optical signal, wherein the item of driver information is produced as a function of the recognized course of the roadway.

22. The method as recited in claim 21, wherein at least one of:
the item of driver information is produced as a function of a position of at least one object in relation to the course of the roadway and the at least one object is recognized from at least the optical signal,
the item of driver information is produced as a function of a dangerousness of a driving situation,
the item of driver information is produced as a function of a visibility condition,
the item of driver information is produced as a function of a signal of at least one sensor including at least one of at least one radar sensor, at least one ultrasonic sensor, and at least one LIDAR distance sensor,
the item of driver information is suitable for representing at least one of at least one object and the course of the roadway, and
the item of driver information includes at least one of at least one light pulse, at least one warning symbol, at least one image marking, at least one segment of an image, at least one acoustic signal, and at least one haptic signal.

23. The method as recited in claim 22, wherein:
the at least one object includes at least one of at least one other motor vehicle and at least one pedestrian.

24. The method as recited in claim 22, wherein:
the method is executed via on a program code of a computer program.
